(19) United States
(12) Patent Application Publication
(10) Pub. No.: US 2024/0172246 A1
(43) Pub. Date: May 23, 2024

(54) IN ALIGNMENT WITH PDCCH MONITORING SKIPPING

(71) Applicant: Fraunhofer-Gesellschaft zur Förderung der angewandten Forschung e.V., München (DE)

(72) Inventors: Dariush MOHAMMAD SOLEYMANI, Erlangen (DE); Gustavo Wagner OLIVEIRA DA COSTA, Erlangen (DE); Elke ROTH-MANDUTZ, Erlangen (DE); Martin LEYH, Erlangen (DE); Dietmar LIPKA, Erlangen (DE); Mehdi HAROUNABADI, Erlangen (DE); Shubhangi BHADAURIA, Erlangen (DE)

(73) Assignee: Fraunhofer-Gesellschaft zur Förderung der angewandten Forschung e.V., München (DE)

(21) Appl. No.: 18/424,857

(22) Filed: Jan. 28, 2024

Related U.S. Application Data
(63) Continuation of application No. PCT/EP2022/069612, filed on Jul. 13, 2022.

(30) Foreign Application Priority Data
Jul. 28, 2021 (EP) 21188308.7

(51) Int. Cl. H04W 72/232; H04W 56/00; H04W 76/20

(52) U.S. Cl. CPC H04W 72/232; H04W 56/0015; H04W 76/20

(57) ABSTRACT

A transceiver configured for communicating in a wireless communication network being operated by at least one base station comprises an antenna unit configured for transceiving wireless signals in the wireless communications network. The transceiver is to monitor a physical downlink control channel, PDCCH to obtain downlink information; and to provide a feature such as a radio measurement in the wireless communication network. The transceiver is to skip monitoring PDCCH by performing no monitoring or by switching a search space of the PDCCH, for a duration of a skipping interval and for aligning the feature with the skipping interval in time.

### CROSS-REFERENCE TO RELATED APPLICATIONS

This application is a continuation of copending International Application No. PCT/EP2022/069612, filed Jul. 13, 2022, which is incorporated herein by reference in its entirety, and additionally claims priority from European Application No. 21188308.7, filed Jul. 28, 2021, which is also incorporated herein by reference in its entirety.

### TECHNICAL FIELD

The present application concerns the field of wireless communication systems or networks, more specifically, a behavior of a user device, UE, in a wireless communication network when reducing power consumption by skipping PDCCH.

### BACKGROUND OF THE INVENTION

FIG. 1 is a schematic representation of an example of a terrestrial wireless network 100 including, as is shown in FIG. 1(a), the core network 102 and one or more radio access networks RAN₁, RAN₂, . . . RAN_{N}. FIG. 1(b) is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile or stationary devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 1(b) shows an exemplary view of five cells, however, the RANₙ may include more or less such cells, and RANₙ may also include only one base station. FIG. 1(b) shows two users UE₁ and UE₂, also referred to as user device or user equipment, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 1(b) shows two further devices 110₁ and 110₂ in cell 106₄, like IoT devices, which may be stationary or mobile devices. The device 110₁ accesses the wireless communication system via the base station gNB₄ to receive and transmit data as schematically represented by arrow 112₁. The device 110₂ accesses the wireless communication system via the user UE₃ as is schematically represented by arrow 112₂. The respective base station gNB₁ to gNB₅ may be connected to the core network 102, e.g. via the S1 interface, via respective backhaul links 114₁ to 114₅, which are schematically represented in FIG. 1(b) by the arrows pointing to “core”. The core network 102 may be connected to one or more external networks. The external network may be the Internet, or a private network, such as an Intranet or any other type of campus networks, e.g. a private WiFi communication system or a 4G or 5G mobile communication system. Further, some or all of the respective base station gNB₁ to gNB₅ may be connected, e.g. via the S1 or X2 interface or the XN interface in NR, with each other via respective backhaul links 116₁ to 116₅, which are schematically represented in FIG. 1(b) by the arrows pointing to “gNBs”. A sidelink channel allows direct communication between UEs, also referred to as device-to-device, D2D, communication. The sidelink interface in 3GPP is named PC5.

For data transmission a physical resource grid may be used. The physical resource grid may comprise a set of resource elements to which various physical channels and physical signals are mapped. For example, the physical channels may include the physical downlink, uplink and sidelink shared channels, PDSCH, PUSCH, PSSCH, carrying user specific data, also referred to as downlink, uplink and sidelink payload data, the physical broadcast channel, PBCH, carrying for example a master information block, MIB, and one or more system information blocks, SIBs, one or more sidelink information blocks, SLIBs, if supported, the physical downlink, uplink and sidelink control channels, PDCCH, PUCCH, PSSCH, carrying for example the downlink control information, DCI, the uplink control information, UCI, and the sidelink control information, SCI, and physical sidelink feedback channels, PSFCH, carrying PC5 feedback responses. The sidelink interface may support a 2-stage SCI which refers to a first control region containing some parts of the SCI, also referred to as the 1^{st} stage SCI, and optionally, a second control region which contains a second part of control information, also referred to as the 2^{nd} stage SCI.

For the uplink, the physical channels may further include the physical random-access channel, PRACH or RACH, used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length, e.g. 1 ms. Each subframe may include one or more slots of 12 or 14 OFDM symbols depending on the cyclic prefix, CP, length. A frame may also have a smaller number of OFDM symbols, e.g. when utilizing shortened transmission time intervals, sTTI, or a mini-slot/non-slot-based frame structure comprising just a few OFDM symbols.

The wireless communication system may be any single-tone or multicarrier system using frequency-division multiplexing, like the orthogonal frequency-division multiplexing, OFDM, system, the orthogonal frequency-division multiple access, OFDMA, system, or any other Inverse Fast Fourier Transform, IFFT, based signal with or without Cyclic Prefix, CP, e.g. Discrete Fourier Transform-spread-OFDM, DFT-s-OFDM. Other waveforms, like non-orthogonal waveforms for multiple access, e.g. filter-bank multicarrier, FBMC, generalized frequency division multiplexing, GFDM, or universal filtered multi carrier, UFMC, may be used. The wireless communication system may operate, e.g., in accordance with the LTE-Advanced pro standard, or the 5G or NR, New Radio, standard, or the NR-U, New Radio Unlicensed, standard.

The wireless network or communication system depicted in FIG. 1 may be a heterogeneous network having distinct overlaid networks, e.g., a network of macro cells with each macro cell including a macro base station, like base station gNB₁ to gNB₅, and a network of small cell base stations, not shown in FIG. 1, like femto or pico base stations. In addition to the above described terrestrial wireless network also non-terrestrial wireless communication networks, NTN, exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the 5G or NR, new radio, standard.

In mobile communication networks, for example in a network like that described above with reference to FIG. 1, like a LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, roadside entities, like traffic lights, traffic signs, or pedestrians. An RSU may have a functionality of a BS or of a UE, depending on the specific network configuration. Other UEs may not be vehicular related UEs and may comprise any of the above-mentioned devices. Such devices may also communicate directly with each other, D2D communication, using the SL channels. When considering two UEs directly communicating with each other over the sidelink, e.g., using the PC5/PC3 interface, one of the UEs may also be connected with a BS, and may relay information from the BS to the other UE via the sidelink interface and vice-versa. The relaying may be performed in the same frequency band, in-band-relay, or another frequency band, out-of-band relay, may be used. In the first case, communication on the Uu and on the sidelink may be decoupled using different time slots as in time division duplex, TDD, systems.

FIG. 2 is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

FIG. 3 is a schematic representation of an out-of-coverage scenario in which the UEs directly communicating with each other are either not connected to a base station, although they may be physically within a cell of a wireless communication network, or some or all of the UEs directly communicating with each other are connected to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 3 which is the out-of-coverage scenario does not necessarily mean that the respective mode 2 UEs in NR or mode 4 UEs in LTE are outside of the coverage 200 of a base station, rather, it means that the respective mode 2 UEs in NR or mode 4 UEs in LTE are not served by a base station, are not connected to the base station of the coverage area, or are connected to the base station but receive no SL resource allocation configuration or assistance from the base station. Thus, there may be situations in which, within the coverage area 200 shown in FIG. 2, in addition to the NR mode 1 or LTE mode 3 UEs 202, 204 also NR mode 2 or LTE mode 4 UEs 206, 208, 210 are present. In addition, FIG. 3, schematically illustrates an out of coverage UE using a relay to communicate with the network. For example, the UE 210 may communicate over the sidelink with UE 212 which, in turn, may be connected to the gNB via the Uu interface. Thus, UE 212 may relay information between the gNB and the UE 210

Although FIG. 2 and FIG. 3 illustrate vehicular UEs, it is noted that the described in-coverage and out-of-coverage scenarios also apply for non-vehicular UEs. In other words, any UE, like a hand-held device, communicating directly with another UE using SL channels may be in-coverage and out-of-coverage.

In a wireless communication system as described above with reference to FIG. 1, FIG. 2 or FIG. 3, a UE communicating over the sidelink may operate in a discontinuous reception, DRX, mode.

Starting from the known technology as described above, there may be a need for enhancements or improvements for a UE communicating over the sidelink and operating in a discontinuous reception, DRX, mode.

### SUMMARY

An embodiment may have a transceiver configured for communicating in a wireless communication network being operated by at least one base station wherein the transceiver is configured for transceiving wireless signals in the wireless communications network; wherein the transceiver is to monitor a physical downlink control channel, PDCCH to obtain downlink information; and to provide a feature in the wireless communication network; wherein the transceiver is to skip monitoring PDCCH by performing no monitoring, for a duration of a skipping interval and for aligning the feature with the skipping interval in time; and wherein for the skipping interval, e.g., a time where the transceiver enters or leaves PDCCH monitoring or enables PDCCH skipping, a time offset is defined to be configured or preconfigured to align/realign an interaction between PDCCH skipping and the feature.

According to another embodiment, a method for operating a transceiver for communicating in a wireless communication network being operated by at least one base station may have the steps of: transceiving wireless signals in the wireless communications network using the transceiver; monitor a physical downlink control channel, PDCCH to obtain downlink information; and to provide a feature in the wireless communication network; skip monitoring PDCCH by performing no monitoring, for a duration of a skipping interval and aligning the feature with the skipping interval in time; such that for the skipping interval, e.g., a time where the transceiver enters or leaves PDCCH monitoring or enables PDCCH skipping, a time offset is defined to be configured or preconfigured to align/realign an interaction between PDCCH skipping and the feature and/or between at least two features.

Another embodiment may have a non-transitory digital storage medium having a computer program stored thereon to perform a method for operating a transceiver for communicating in a wireless communication network being operated by at least one base station, having the steps of: transceiving wireless signals in the wireless communications network using the transceiver; monitor a physical downlink control channel, PDCCH to obtain downlink information; and to provide a feature in the wireless communication network; skip monitoring PDCCH by performing no monitoring, for a duration of a skipping interval and aligning the feature with the skipping interval in time; such that for the skipping interval, e.g., a time where the transceiver enters or leaves PDCCH monitoring or enables PDCCH skipping, a time offset is defined to be configured or preconfigured to align/realign an interaction between PDCCH skipping and the feature and/or between at least two features, when said computer program is run by a computer.

### BRIEF DESCRIPTION OF THE DRAWINGS

Embodiments of the present invention are now described in further detail with reference to the accompanying drawings, in which:

FIG. 1 shows a schematic representation of an example of a wireless communication system;

FIG. 2 is a schematic representation of an in-coverage scenario in which two UEs directly communicating with each other are both connected to a base station;

FIG. 3 is a schematic representation of an out-of-coverage scenario in which the UEs directly communicate with each other;

FIG. 4 illustrates a conventional DRX mode at a user device communication with a base station;

FIG. 5 is a schematic representation of a wireless communication system including a transmitter, like a base station, and one or more receivers, like user devices or UEs, capable of operating in accordance with embodiments of the present invention;

FIG. 6 illustrates an embodiment of an example of out-of-sync or in-sync and triggering RLF procedure;

FIG. 7 illustrates an embodiment of a beam management concept based on associated synchronization signal;

FIG. 8 illustrates a potential implementation of embodiments in which the time offset or flag bit to be applied when activating PDCCH skipping to realize the alignment between two features is illustrated;

FIG. 9 illustrates a potential implementation of an embodiment of applying a tolerance window when activating PDCCH skipping; and

FIG. 10 illustrates an example of a computer system on which units or modules as well as the steps of the methods described in accordance with the inventive approach may execute.

### DETAILED DESCRIPTION OF THE INVENTION

Embodiments of the present invention are now described in more detail with reference to the accompanying drawings in which the same or similar elements have the same reference signs assigned.

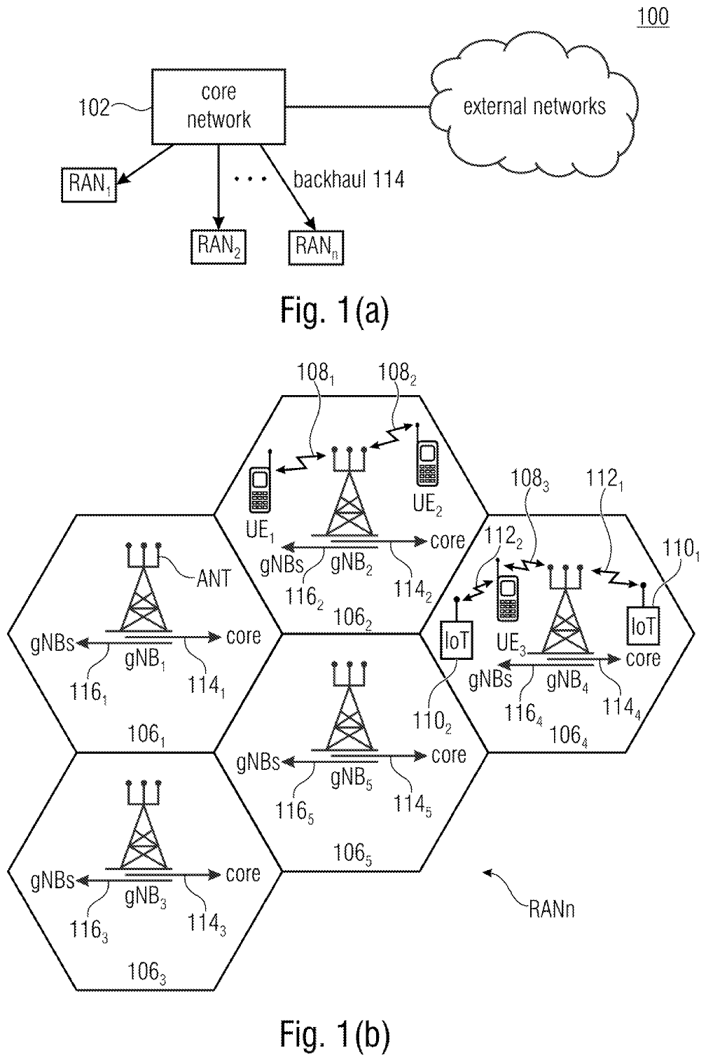

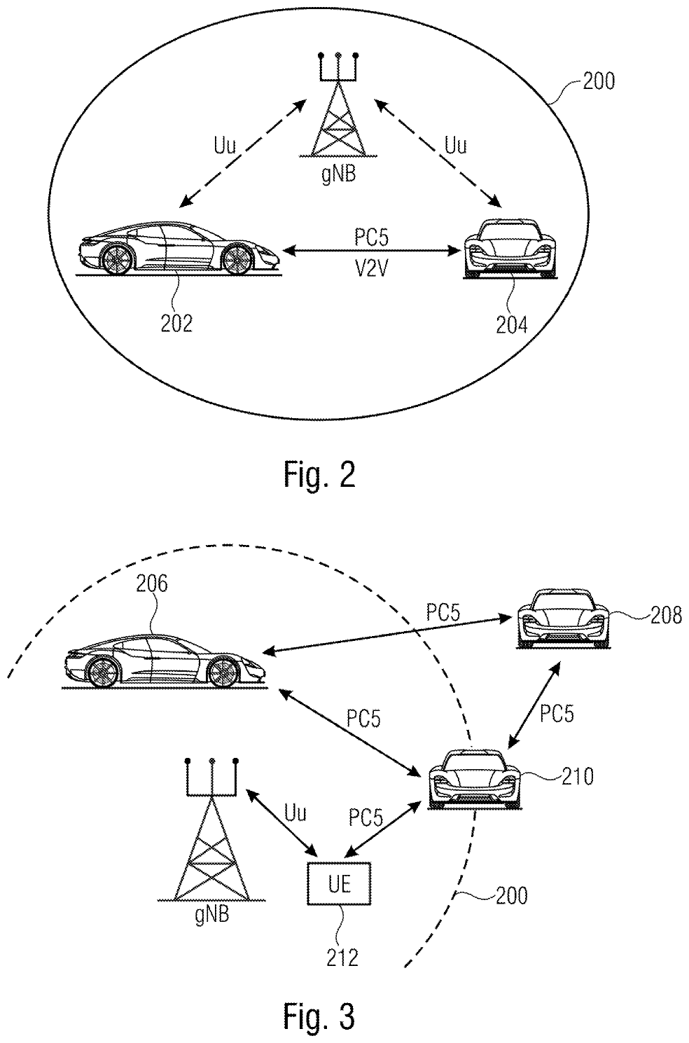

In the wireless communication system or network, like the one described above with reference to FIG. 1, FIG. 2 or FIG. 3, a sidelink communication among the respective user devices may be implemented, for example, a vehicle-to-vehicle communication, V2V, a vehicle-to-anything communication, V2X, or any device-to-device communication, D2D, among any other use devices, for example, those mentioned above. However, in a NR-Uu operation or in a sidelink operation, like a PC5 operation, the UE is awake at all times and monitors the control channel in every subframe in order to be able to receive from the network and from another UE, respectively. This increases the power consumption at the UE, since the UE is always on, even when there is no data to be transmitted or received. For vehicular use cases, like NR V2X, power saving may not be a concern since the vehicular UEs, V-UEs, are devices with a sufficient power source, e.g., an onboard battery of the vehicle.

However, the sidelink communication or the sidelink PC5 operation is not limited to the operation of vehicular UEs, but other UEs with a limited or finite power supply, like regular user devices including a battery that needs to be recharged regularly, may communicate over the sidelink. Such UEs may include so-called vulnerable road users, VUEs, like a pedestrian UE, P-UE, or first responder devices for public safety use cases, or IoT devices, like general IoT UEs or industrial IoT UEs. For these types of UEs, since they are not connected to a constant power supply but rely on their battery, power saving is important.

To reduce the power consumption at a UE in NR, the discontinuous reception, DRX, is employed on the Uu interface. For NR, for example, further details of the DRX operation are defined in 3GPP TS 38.321. DRX is a mechanism where the UE goes into a sleep mode for a certain period of time, during which it does not transmit or receive any data. The UE wakes for another period of time, where it may transmit and receive data. One of the key aspects of DRX is the synchronization between the UE and the network in terms of its wake-up and sleep cycles, also referred to as the DRX cycles. In a worst-case scenario, the network tries to send data to the UE being in the sleep mode so that, when the UE wakes up, there is no data to be received. In the NR-Uu interface this situation is prevented by maintaining a well-defined agreement between the UE and the network or system in terms of the sleep and wake-up cycles. In other words, by configuring a UE with DRX by the gNB, the DRX is synchronized with the gNB. A DRX cycle includes both the ON time and the OFF time within a fixed time interval, and for the NR Uu interface a short DRX cycle and a long DRX cycle is defined, where a short DRX cycle may span a few symbols within a time slot, and a long DRX cycle may span an entire time slot or multiple time slots. An inactivity timer may specify the number of consecutive control messages for which the UE may be active after successfully decoding of a control message that indicates a new transmission, with the following configuration:
the timer is restarted upon receiving a control message for a new transmission and/or any other control message which is addressed to the UE, e.g. scrambled by UE-specific RNTI or group-specific RNTI,
upon the expiry of the timer, the UE goes to DRX mode or OFF time.

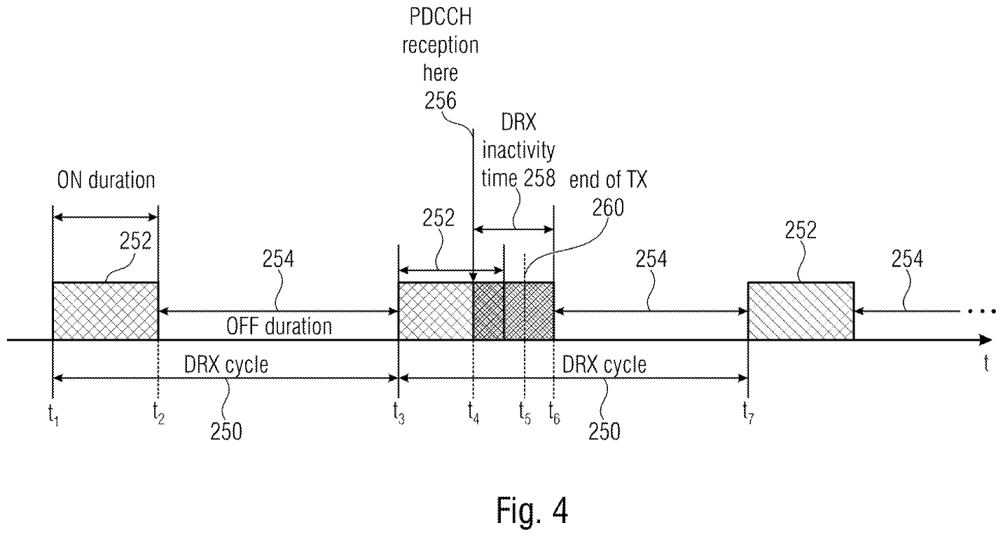

FIG. 4 illustrates a DRX mode using an inactivity timer. The DRX configuration defines a DRX cycle 250 spanning a certain time and including an on period or ON duration 252 at the beginning of a DRX cycle, followed by an off period or OFF duration 254. On the Uu interface, the UE is awake or active during the ON durations 252. In addition, whenever a transmission or a packet is received during an ON duration, the above-mentioned timer, also referred to as an inactivity timer, is started. In FIG. 4, the reception of a data packet is indicated at 256 during the ON duration 252 of the DRX cycle that starts at time t3. For example, a DCI 256 may be received by the UE on the PDCCH which, in turn, triggers the inactivity timer to be started thereby adding the DRX activity time 258 so that the original ON duration 252 as defined by the DRX configuration is extended from the time t4 to the time t6. This enables a transmitter to send further data associated with the DCI 256 on the PSCCH. In case a transmitter does not intend to send any further data, it may send a DRX command to put the UE into the inactive mode or into the sleep mode. For example, at any time during the inactivity timer duration 258 the UE may receive a DRX command indicating that no further data is to be expected from the transmitter or that the transmitter does not send any further data. Responsive to receiving such an end of transmission signaling 260, for example at a time t5 that is before the end t6 of the inactivity timer duration 258, the UE may return into the sleep mode. It is noted that the end of transmission signaling 260 may also be received for a transmission that does not trigger the inactivity timer so that a regular ON duration 252, as defined by the DRX communication, responsive to the signaling 260 may be terminated before the configured end of the ON duration 252.

The process described above with reference to FIG. 4 for placing a UE operating in the DRX mode into the sleep state or the inactive state responsive to the end of transmission signaling 260 so as to terminate the ON duration 252 before its configured end or to terminate an extended ON duration before the end of the inactivity timer duration 258, works well when the UE is communicating with a base station because the base station is aware about all transmissions for a certain UE, and based on this knowledge, the base station may decide to signal an end of transmission 260 to the UE in case there are no further transmissions for the UEs scheduled. However, the situation is different when considering the sidelink communication.

Over the sidelink, the UE may communicate with several other sidelink UEs which, when activing as transmitters, transmit a unicast message or a groupcast message or a broadcast message, so that the UE may receive from the other sidelink UEs a plurality of transmissions. However, the respective transmitters or TX UEs are not aware of any other ongoing transmissions for the receiving UE or RX UE, so that it is not possible to provide an end of transmission signaling or a sleep command 260 as explained above with reference to FIG. 4, because putting the receiving UE into the sleep mode prohibit the RX UE from receiving data or packets of another ongoing transmission from a different transmitter. For example, the sidelink unicast communication describes a one-to-one communication between two UEs via the sidelink. Therefore, when a transmitter sends the end of transmission or sleep command 260, the receiver may stop listening for further packets from this transmitter. However, as the receiver may have several ongoing transmissions, receiving the end of transmission or sleep command 260 from one transmitter may not be equated to a go to sleep indication as in the case of transmitting over the Uu interface because the receiver may still have to listen for other ongoing transmissions on other links. In case of a sidelink groupcast communication, several UEs within a group may send data, and it not possible to apply the Uu approach described above with reference to FIG. 4 because a UE in the group that transmits or sends data is not aware of other UEs that communicate with the receiving UE. Thus, the UE transmitting the groupcast may not signal to the receiving UE that no further data is expected and that the UE may go to sleep. This is also true for a sidelink broadcast communication in which one transmitter provides a communication to all sidelink UEs, however, also this transmitter is not aware whether the receiving UEs have any other ongoing transmissions on other links so that it may also not send an end of transmission command 260 in a way as described above with reference to FIG. 4 calling a UE to go back into the sleep mode or sleep state.

To reduce the power consumption also at a UE in NR communicating over the sidelink, the DRX mode may also be implemented on the sidelink. A UE communicating over the sidelink may be in-coverage or out-of-coverage, as explained above with reference to FIG. 2 and with reference to FIG. 3. When the UE is in-coverage, even when operating over the sidelink in the DRX mode, the gNB, which is aware of the DRX cycles, handles the resource allocation for transmissions by a UE over the sidelink. This is not possible when the UE is out-of-coverages, e.g., in case the UE operates in Mode 2. Therefore, signaling an end of a transmission by a certain transmitter is not implemented for a UE communicating with other UEs over the sidelink and operating in the DRX mode for placing the UE into the inactive mode or sleep mode.

Thus, the known approach for the Uu interface for placing a UE into the sleep mode as soon as a transmission is terminated, thereby improving the power saving properties, is not available for a sidelink UE so that the power saving possibilities for a sidelink UE operating in a DRX mode may be more limited when compared to a UE communicating over the Uu interface.

Embodiments of the present invention provide enhancements or improvements of the power saving possibilities or capabilities of a UE communicating over the sidelink and operating in a discontinuous reception, DRX, mode. Embodiments of the present invention may be implemented in a wireless communication system as depicted in FIG. 1, FIG. 2 or FIG. 3 including base stations and users, like user equipment, UE, mobile terminals or IoT devices.

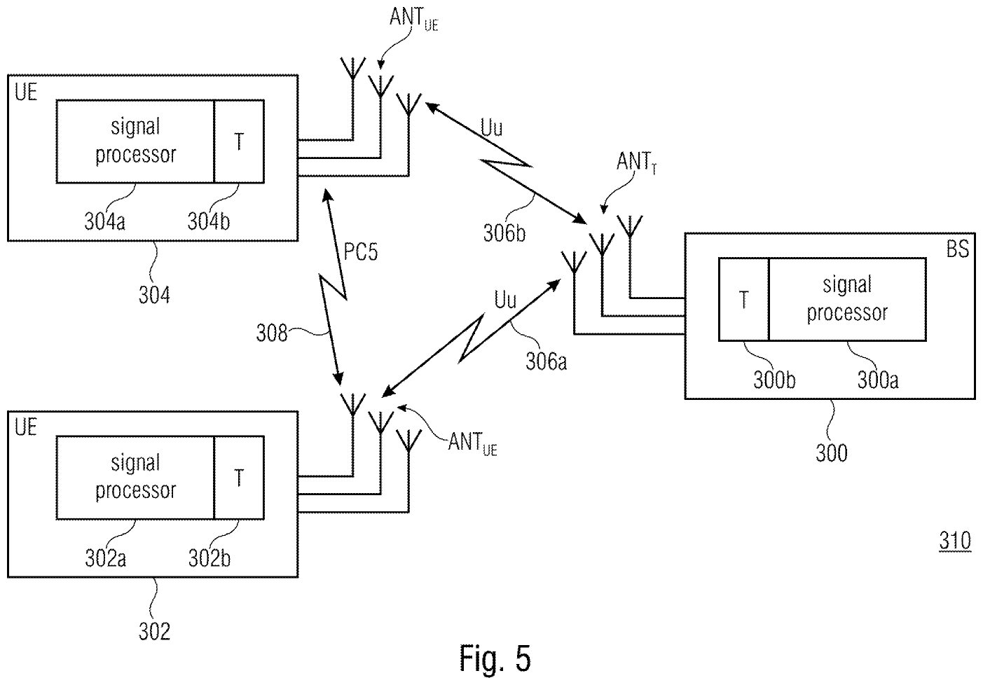

FIG. 5 is a schematic representation of a wireless communication system including a transmitter 300, like a base station, and one or more receivers 302, 304, like user devices, UEs. The transmitter 300 and the receivers 302, 304 may communicate via one or more wireless communication links or channels 306a, 306b, 308, like a radio link. The transmitter 300 may include one or more antennas ANT_{T} or an antenna array having a plurality of antenna elements, a signal processor 300a and a transceiver 300b, coupled with each other. The receivers 302, 304 include one or more antennas ANT_{UE} or an antenna array having a plurality of antennas, a signal processor 302a, 304a, and a transceiver 302b, 304b coupled with each other. The base station 300 and the UEs 302, 304 may communicate via respective first wireless communication links 306a and 306b, like a radio link using the Uu interface, while the UEs 302, 304 may communicate with each other via a second wireless communication link 308, like a radio link using the PC5 or sidelink, SL, interface. When the UEs are not served by the base station or are not connected to the base station, for example, they are not in an RRC connected state, or, more generally, when no SL resource allocation configuration or assistance is provided by a base station, the UEs may communicate with each other over the sidelink. The system or network of FIG. 5, the one or more UEs 302, 304 of FIG. 5, and the base station 300 of FIG. 5 may operate in accordance with the inventive teachings described herein.

Embodiments of the present disclosure relate to the finding, that during the OFF duration one or more PDCCH may remain unreceived or undecoded by the transceiver, e.g., a UE. However, the transceiver has to perform additional tasks, like performing measurements on the channel and/or providing measurement reports. Such activities may prevent the transceiver from efficient power saving in a deep-sleep mode and/or may profit from an alignment with regard to the PDCCH skipping.

A transceiver, such as a UE, may, e.g., to enhance communication execute or perform a Physical Control Channel PDCCH monitoring, i.e., they may monitor the PDCCH, e.g., to obtain information like downlink control information, DCI, contained therein. However, there may exist times or time intervals in which such a PDCCH monitoring may not be necessary allowing the UE to skip PDCCH monitoring which is referred to as PDCCH skipping.

For same or different purposes, UE may perform measurements on the radio environment, such as measurements on the radio resource management, RRM, radio link monitoring, RLM, and/or measurements to allow a beam failure detection, BFD and/or radio link failure, RLF.

Both, PDCCH monitoring and measurements use energy or electrical power that is often received from a battery.

For prolonging battery lifetime, UE may skip PDCCH monitoring and/or may reduce an extent of measurements, i.e., a number of measurements and/or a granularity may be reduced and/or measurements may be skipped for a time interval.

The UE power consumption is a topic for continuous improvement in 3GPP standardization. Motivated by previous studies [2], in Release 17, several features are being discussed for RRC Connected mode:
Reducing the power spent on PDCCH monitoring, e.g. via PDCCH skipping/search space switching (on Power Saving work item, mainly RAN1)
Reducing the power consumed on RRM measurements when the UE is stationary or low mobility (on RedCap work item, mainly RAN2)
Reducing the power consumed on RLM/BFD measurements when the UE is stationary or low mobility (on Power saving work item, mainly RAN4)

As these features are being discussed in separate work items and working groups, they are being defined independently. Nonetheless, the inventors have found that they interact in terms of power saving potential. In particular, if the UE reduces PDCCH monitoring, but still needs to perform measurements, it will save energy due to skipping PDCCH processing, but it will not be able to enter a strongly power saving mode such as micro-sleep or any other type of sleep mode based on e.g. DRX.

More specifically in [1], RAN4 discusses the necessity of alignment between PDCCH skipping that is being discussed in RAN1 and other feature for example RLM/Beam Failure Detection (BFD) relaxation, which is under discussion in RAN4.

A UE is configured to skip PDCCH monitoring or RLM/RLF procedures to reduce energy consumption and prolong battery life. RLM/RLF may be configured to be based on PDCCH monitoring, for example, to measure RSs transmitted in PDCCH. Intuitively, the timing of these features needs to be aligned with PDCCH skipping and monitoring feature to avoid any possible conflict among the related features and assist the UE with energy-saving more efficiently.

This invention strives to resolve the interaction problem between PDCCH skipping and monitoring feature and other corresponding features, for example RLM or RRM.

The physical downlink control channel (PDCCH) transports downlink control information (DCI), including e.g. uplink and downlink scheduling information for a specific user equipment (UE) or a group of UE. In NR and LTE, the UE performs blind decoding for a set of PDCCH candidates. PDCCH candidates to be monitored are configured for a UE by means of search space (SS) sets. A UE is configured with up to 10 SS sets each for up to four BWPs in a serving cell. Therefore, a UE can be configured with up to 40 SS sets. A UE occasionally has to monitor a large number (up to 40) of PDCCH candidates or CCEs which increases the UE complexity and causes increasing power consumption of the UE.

RAN1 #104 discussed two candidate solutions for PDDCH skipping and monitoring configuration, search space set group switching (SSSG) and PDCCH adaptation, by which the power consumption can be further reduced [3].

In the SSSG method, different SSSG types are applied to emulate the PDCCH skipping or monitoring. The SSSG types can be configured by L1 signalling, i.e., DCI or in implicit manner. Alternatively, in PDCCH adaptation, PDCCH skipping or PDCCH monitoring are configured by an explicit L1 signalling, e.g., DCI.

In this context, the following agreements were made during RAN1 #104[3], not excluding others:
Strive for a common design for DCI based PDCCH monitoring adaptation in active time for an active BWP to support functionalities inclusive of both SSSG switching and PDCCH skipping for a duration.

For DCI based PDCCH skipping in active time for an active BWP (if supported), the following can be further considered,
Explicit indication of PDCCH adaptation
   Scheduling DCI
   Non-scheduling DCI
   additional indication mechanism
DCI dynamically indicates a duration/periodic interval for skipping
PDCCH skipping for a duration indicated by minimum scheduling offset
Others are not precluded
For DCI based SSSG switching in active time for an active BWP (if supported), the following can be further considered,
   Explicit indication of PDCCH adaptation
      Non-scheduling DCI
      additional indication mechanism
      DCI dynamically indicates a duration for the switched SSSG, UE switch back to previous/default SSSG after duration ends
   Timer-based SSSG switching, including RRC configured a timer, UE switch back after timer expired.
   SSSG activation/deactivation

RLM is an important measure undertaken by the physical layer of a UE in the downlink of a primary cell to measure and report the out-of-sync and sync to the higher layer [4]. The configured RLM resources can be all SSBs or channel state information, CSI, RS, i.e., CSI-RS, and the measurements are performed on the active bandwidth part configured for the UE.

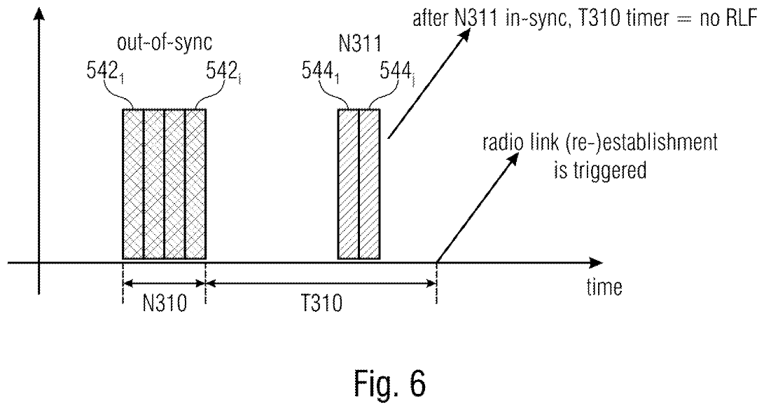

Radio link (re-)establishment may be indicated if timer T310 is expired which is started upon receiving a number of i consecutive N310 of out-of-sync 542₁ to 542ᵢ. The UE then initiates a re-establishment RRC procedure. If during T310 runtime the number of j consecutive in-sync messages 544₁ to 544ⱼ, N311, is received prior to the T310 expiring, the procedure is stopped. FIG. 6 illustrates an example of out-of-sync or in-sync and triggering RLF procedure.

In NR, beam management is a paramount feature that provides a better link budget to achieve reliability and spectral efficiency, and energy efficiency at the UE and the network sides.

The beam management comprises several procedures, which comprises the following:
Beam sweeping
   gNB transmits the beam in some preconfigured direction in a burst in a specific time interval. For example, SSB can be assigned to a specific antenna beam direction and transmitted within the cell, i.e., SSB burst.
Beam measurement/determination
   A UE can measure the beam signal strength to select the best beam for its transmission. In Idle mode, synchronization signal, SS, associated with the predefined beam, assists a UE to determine an appropriate beam. In connected mode, the measurement and beam determination are based on measuring the CSI-RS in downlink, DL.
Beam reporting and Beam failure recovery
   The beam reporting in idle is based on the RACH preamble transmission by which a UE notifies the gNB about the best beam. In the connected mode, the user will provide feedback using CSI-RS. In poor channel condition, the user may request a recovery by indicating a new SS block or CSI-RS.

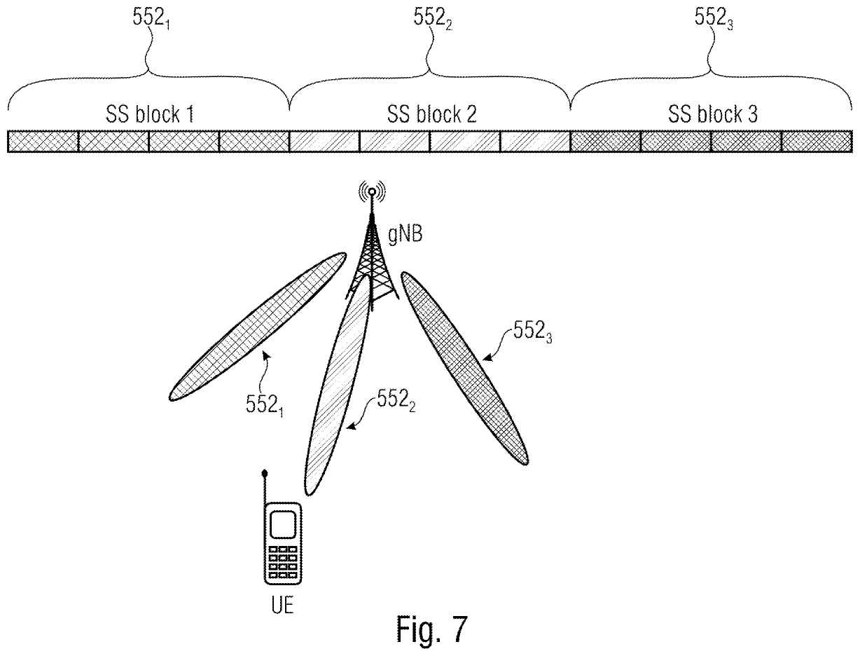

FIG. 7 shows a beam management concept based on associated synchronization signal, SS, block with an example number of three blocks 552₁ to 552₃.

In RAN4 #98-bis-e Meeting, RLM and beam management (BM) relation were discussed and the following agreement regarding to relaxation scenarios, criteria and factors were achieved:

### Feasible Scenarios for Relaxation:

RAN4 conclude the feasible scenario and will define the RLM/BFD requirements for R17 UE measurements relaxation for RLM and/or BFD in work phase for the following cases,
Case 1: SSB based RLM/BFD measurement relaxation in FR1
Case 2: CSI-RS based RLM/BFD measurement relaxation in FR1
Case 3: CSI-RS based RLM/BFD measurement relaxation in FR2
Case 4: SSB based RLM/BFD measurement relaxation in FR2

### Criteria of RLM/BFD Relaxation—General

Whether relaxed RLM/BFD requirements can be applied depends on both the serving cell quality and UE mobility state
For example, a good serving cell quality criteria of RLM/BFD relaxation may be defined as the radio link quality is better than a threshold.
   FFS radio link quality>Qout+X (dB) for RLM
   FFS radio link quality>Qout,LR+Y (dB) for BFD relaxation.
   FFS how to derive the values of X, Y
For example, the radio link quality in good serving cell quality criteria for R17 RLM/BFD relaxation may be based on SINR

RRM relaxation means the UE is allowed to reduce the amount of measurements performed in order to enable RRM functions (mobility). In Release 16, RRM relaxation was specified for RRC idle and inactive modes. Further possibilities and power saving gains are documented on [2].

So far there is one agreement on RRM relaxation on connected mode [5]:

### Agreements:

An RSRP/RSRQ based stationarity criterion (Working Assumption: the same as in idle/inactive) can be configured for UEs in RRC Connected. If the criterion is met, this is reported to the network (FFS how/when). It is FFS whether, based on this, besides possibly reconfiguring RRM measurements (up to network implementation), the network can enable RRM measurement relaxation (FFS whether same method as in Idle/Inactive)

This means that the network will know when RRM relaxation is used at the same time as PDCCH monitoring/skipping. Therefore, the methods on this solution could be applied accordingly which is subject to the present invention.

According to an embodiment, a transceiver, e.g., a UE in FIGS. 1 and/or 5 and/or a vehicle in FIGS. 2 and/or 3 may be configured for communicating in a wireless communication network being operated by at least one base station. The transceiver may comprise an antenna unit configured for transceiving wireless signals in the wireless communications network. The transceiver is to monitor a physical downlink control channel, PDCCH to obtain downlink information; and to provide a feature such as a radio measurement, e.g., RLM, beam reporting, BFD, RRM, or the like in the wireless communication network. The transceiver may to skip monitoring PDCCH, i.e., it may perform PDCCH skipping, by performing no monitoring or by switching a search space of the PDCCH, for a duration of a skipping interval, e.g., a time between status “PDCCH on” and for aligning the feature with the skipping interval in time. That is, the transceiver aligns measurements with PDCCH skipping.

According to an embodiment, the transceiver is to obtain aligning information, e.g., instructions/DCI/ON-OFF or the like indicating a relationship between the skipping of the monitoring PDCCH and the feature and to align the feature with the skipping interval using the aligning information.

According to an embodiment the alignment information comprises at least one of:

a time information indicating a time offset of the feature with respect to an end of the skipping interval;

a tolerance information indicating a tolerance in time to execute the feature with regard to a reference in time at which the feature is scheduled by the wireless communication network; the tolerance in time indicating an amount of time by which the transceiver may deviate from the reference in time, e.g., a tolerance window

a suspending information indicating that the feature is to be suspended, e.g., a radio measurement is to be skipped, e.g., opportunistic relaxation

an enablement information indicating to that PDCCH skipping is enabled or disabled; and

an PDCCH occurrence information indicating an occurrence of a later PDCCH in time, e.g., adynamic DRX

According to an embodiment the transceiver is to monitor the PDCCH with a first pattern in time, which may include periodicity but may be without periodicity, e.g., for dynamic DRX. The transceiver may perform a plurality of features including the feature with a second pattern in time.

According to an embodiment the transceiver is to operate in a power saving mode, e.g., a sleep mode or a deep sleep mode, during the skipping interval.

According to an embodiment the transceiver is to perform the feature on at least a part of the PDCCH.

Embodiments of the present invention provide a computer program product comprising instructions which, when the program is executed by a computer, causes the computer to carry out one or more methods in accordance with the present invention.

Embodiments of the present invention relate to an interaction between PDCCH skipping and other features such as measurements.

A transceiver which is also referred to as a UE in a non-limiting way may be configured to perform PDCCH monitoring/skipping or apply search space group switching. In the following description, PDCCH monitoring may refer to a time where the UE is actively decoding the PDCCH or the time where the UE is applying a certain search space group. In contrast, PDCCH skipping may refer to a time where the UE is not decoding the PDCCH or a time where the UE is using another search space group (e.g. a null search space).

The alignment, e.g. timing, between the PDCCH skipping and other features, e.g., DRX, should be taken into consideration. The following ideas underlie the present embodiments:
1. When a UE will enter or leave PDCCH monitoring or enables/allows PDCCH skipping a time offset can be defined to be (pre-) configured to (re-)align interaction between PDCCH skipping and other features.
2. The network may send an indication to the UE that measurements (RLM, BFD, RRM) can be performed slightly before or slightly after the configured time in order to perform the measurements when PDCCH is being monitored, instead of when it is being skipped, i.e., they can be performed outside the skipping time interval.
3. The network may send an indication that the UE is allowed to interrupt all or some particular activity during the complete duration at which the PDCCH is being skipped. This may be conditional on the UE being on a relaxation mode.

Further details are specified in the following subsections. It is to be noted that embodiments and aspects described herein describe advantageous findings of the inventors which may be combined with each other in any way, e.g., to be applied commonly and/or in different operating modes leading to a transceiver or other network entity or structure that provides for features of different embodiments and/or aspects.

### Embodiment 1

### Aspect 1: Time Offset for Re-Alignment

A transceiver in accordance with this embodiment and/or aspect may operate in accordance with, for the skipping interval, e.g., a time where the transceiver enters or leaves PDCCH monitoring or enables PDCCH skipping, a time offset which is defined to be configured or preconfigured to align/realign an interaction between PDCCH skipping and the feature and/or between at least two features.

According to an embodiment, the transceiver is to apply a time offset to extend an already configured timer for the feature based on reference symbol monitoring such as configured CSI-RS, synchronization blocks, SSB or SSB based measurement timing configuration, SMTC to align the feature with the skipping interval in time.

According to an embodiment the feature comprises at least one of:
Measurements for RLM/RLF feature, and/or
Beam failure detection feature, and/or
RRM feature, and/or
any other corresponding features

According to an embodiment the time offset is configured or preconfigured considering at least one or any combination of the following parameters:
a reference symbol periodicity, e.g. CSI-RS periodicity
a synchronization block, SSB, periodicity
a SSB based measurement timing configuration, SMTC, window periodicity
a measurement gap configuration
a relative or absolute velocity of users, e.g., the transceiver
a Quality of Service, QoS, profile, e.g., packet delay budget
a traffic load of the transceiver (e.g. queue length, number of data flows, etc.)
a Validity timer set for PDCCH
a discontinuous reception, DRX, configuration
a transceiver category
a PDCCH skipping time interval
a beam configuration

According to an embodiment the transceiver is configured for applying the time offset to perform the PDCCH skipping during the skipping interval until a next SMTC window, wherein the transceiver is to perform PDCCH monitoring during the next SMTC window.

According to an embodiment the transceiver is to receive a signal comprising information indicating the time offset, e.g., indicating a time value or a flag bit, the information indicating to do PDCCH skipping until the end of a next measurement gap and to start monitoring PDCCH again just after the measurement gap.

According to an embodiment the transceiver is to provide a report comprising a result of an execution of the feature; wherein the transceiver is to provide the report with a delay with respect to a reference timing and for applying the delay according to a received delay information.

According to an embodiment the transceiver is to provide the feature in a periodic or semi-persistent manner and is implemented for PDCCH skipping; wherein the transceiver is to skip the measurements with the time offset.

According to an embodiment the time offset comprises a same value in time to a skipping time duration indicating the duration of the skipping interval, the skipping time duration indicated by a radio resource control, RRC, or downlink control information, DCI, of the wireless communication network.

According to an embodiment the transceiver is to derive the time offset from a radio resource control, RRC, message such as in a PDCCH-Config field description, or from a downlink control information, DCI, of the wireless communication network.

According to an embodiment the transceiver is to evaluate a radio resource control, RRC, message or a downlink control information, DCI, of the wireless communication network for a time offset bit indicating information that toggles a flag that mandates the transceiver to consider or neglect the time offset based on configured time duration for PDCCH skipping.

According to an embodiment the transceiver is to extend a measurement report or measurement of the transceiver with information indicating an inactivity timer responsive to an indication or pre-configuration and for a case where the previous measurement is insufficient for the wireless communication network due to an activation of PDCCH skipping.

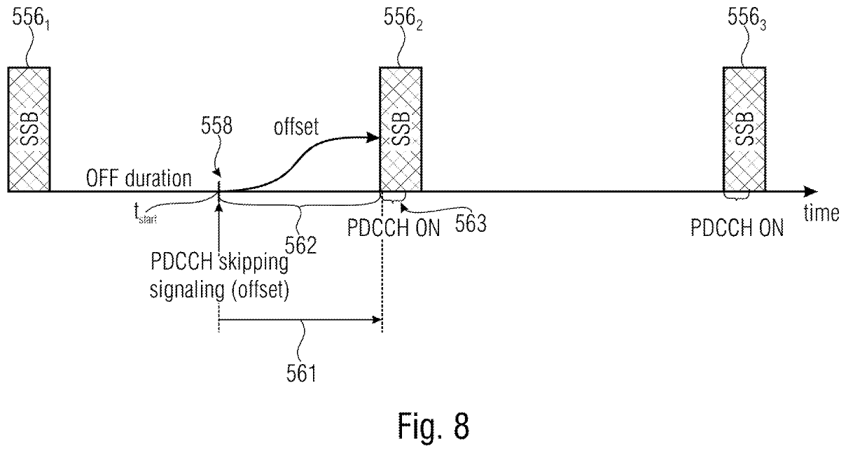

As illustrated in connection with an illustrative example in detail making reference to FIG. 8, the OFF duration 254 may be initiated, e.g., responsive to an explicit signaling or responsive to an implicit signaling to start PDCCH skipping at a time tₛₜₐᵣₜ and may skip 561 monitoring PDCCH. Together with such information, the transceiver may obtain information, e.g., by signaling, configuration or pre-configuration about a time offset 562 to an SSB Block 556, e.g., SSB block 556₂ which is to be measured by a transceiver. Having knowledge about the time where SSB 556₂ to be measured is expected allows the transceiver to go into a sleep mode or deep-sleep mode until the expected time of the SSB 556₂. Then, the transceiver may end skipping PDCCH and may monitor the PDCCH during PDCCH ON 563. The time offset may be used by the transceiver to avoid performing possibly unnecessary actions such as decoding of the channel as the transceiver is aware that there is no interesting content to be received.

Alternatively or in addition, the transceiver, e.g., a UE, may use the time offset to align two or a higher number of features/functions thereby allowing the transceiver to avoid or refrain actions during a certain period of time to save energy. Any feature may be aligned in time or may be aligned temporally, in particular features that consume energy when being provided or executed which may comprise a measurement, a calculation, a transmission of a signal a reception of a signal and/or processing thereof.

The time offset may be applied to extend the already configured timer for the intended features to align PDCCH monitoring/skipping with features based on reference symbol monitoring (e.g. configured CSI-RS), synchronization blocks (SSB) or SSB based measurement timing configuration (SMTC), for example:
Measurements for RLM/RLF feature, and/or
Beam failure detection feature, or
RRM feature, or
Any other corresponding features

The time offset may be (pre-) configured considering at least one or any combination of the following parameters:
Reference symbol periodicity (e.g. CSI-RS periodicity)
SSB periodicity
SMTC window periodicity
Measurement gap configuration
Relative or absolute velocity of users
QoS profile, e.g., packet delay budget
Traffic load of UE (e.g. queue length, number of data flows, etc.)
Validity timer set for PDCCH
DRX configuration
UE category
PDCCH skipping time interval
Beam configuration

Alternatively or in addition, the time offset may also be an indication to perform PDCCH skipping until next SMTC window and perform PDCCH monitoring during SMTC window. The time offset or flag bit can also be an indication to do PDCCH skipping until the end of next measurement gap and start monitoring PDCCH again just after the measurement gap. This is particularly important as the UE may need to re-tune frequency neighbor cell measurement in other carrier frequencies, and thus it will not be able to receive PDCCH indications.

As an example, it may happen that a UE to be configured for both an aperiodic measurement and PDCCH skipping. In such case, the UE is mandated to defer the measurement report as much indicated in RRC or DCI signaling.

Another example, when a UE is configured for both periodic or semi-persistent measurement and PDCCH skipping, the UE may skip the measurements with a time offset. Wherein the time offset is taken the same value to the skipping time duration configured for PDCCH skipping indicated by RRC or DCI.

Wherein the time offset can be (pre-) configured by RRC e.g. in PDCCH-Config field descriptions or DCI.

The time offset can be derived through an explicit RRC or DCI signaling through as explained above, and/or one bit in RRC or DCI may be used to toggle a flag that mandates the UE to consider/neglect the time offset based on configured time duration for PDCCH skipping. Alternatively or additionally, a UE may extend its measurement reporting or measurement to the inactivity timer when it is indicated or pre-configured and the previous measurement is not sufficient due to PDCCH skipping activation.

In FIG. 8 one potential implementation of the time offset or flag bit to be applied when activating PDCCH skipping to realize the alignment between two features is illustrated.

### Aspect 2: Measurement Timing Tolerance Window

According to an embodiment the transceiver is to receive, from the wireless communication network, an indication indicating that the feature, e.g., measurements like RLM, BFD and/or RRM, can be performed by the transceiver prior and/or after a configured time and when PDCCH is monitored by the transceiver and outside the skipping interval.

According to an embodiment the transceiver is to provide the feature with a periodicity; wherein the transceiver is to receive, from the wireless communication network, an indication to deviate from the periodicity and wherein the transceiver is to deviate from the periodicity during the skipping interval accordingly.

According to an embodiment the transceiver is to provide the feature with respect to a serving cell of the wireless communication network and with respect to at least one intra-frequency neighbor cell around and during an active time outside the skipping interval during which the transceiver is to receive PDCCH and in case of a grant physical data shared channel, PDSCH

According to an embodiment the transceiver is to perform the feature during a feature interval and to select the feature interval as having a closest distance in time with respect to a start or an end of the skipping interval and to be outside the skipping interval.

According to an embodiment the transceiver is to perform the feature at any time within a tolerance time window in alignment with the skipping interval.

According to an embodiment the periodicity indicates periodic instances of time and wherein the transceiver is to perform the feature in advance of an associated periodic instance of time to deviate from the periodicity; and/or to perform the feature delayed with respect to an associated periodic instance of time to deviate from the periodicity.

According to an embodiment the transceiver is to provide the feature within a tolerance window in time with respect to a regular provision; wherein a start, an end and/or a duration of the tolerance window is based on at least one of:
a reference symbol periodicity, e.g. a CSI-RS periodicity
a relative or absolute velocity of the transceiver;
a QoS requirement such as a delay;
a validity timer set for the PDCCH;
a discontinuous reception, DRX, configuration;
a transceiver category; and
a transceiver battery power level.

Measurements based on reference signals are typically done with a certain periodicity. When the network activated PDCCH skipping, the measurement time may fall exactly within the period where PDCCH is skipped. This will prevent the UE to perform a microsleep. In order to avoid that situation the network may send an indication to the UE that the timing for measurement may not be exact.
The UE should be allowed to perform measurements on the serving cell and intra-frequency neighbor cells only around and during the active time when it is receiving PDCCH and in case of a grant PDSCH. The wake-up period may be longer than the time needed for PDCCH/PDSCH reception, i.e. to start the measurement period some time in advance and extend it after the reception, for example for performance reasons or if needed reference signals are not available during PDCCH/PDSCH reception. The extension for performance reasons, however, is an implementation and design decision.
The UE should perform the measurement at the closest occasion where the PDCCH is monitored.
The UE can perform the measurement at any time within a tolerance window in alignment with PDCCH skipping time interval.
The UE may perform the measurement in advance (perform it slightly earlier)
The UE may delay the measurement (perform it slightly later)

The normal window and tolerance window may take different values also considering, e.g. one or any combination of the following parameters:
Reference symbol periodicity (e.g. CSI-RS periodicity)
Relative, for example when users are inside a train, or absolute velocity of users
QoS requirements (e.g. delay)
Validity timer set for PDCCH
DRX configuration
UE category
UE battery power level

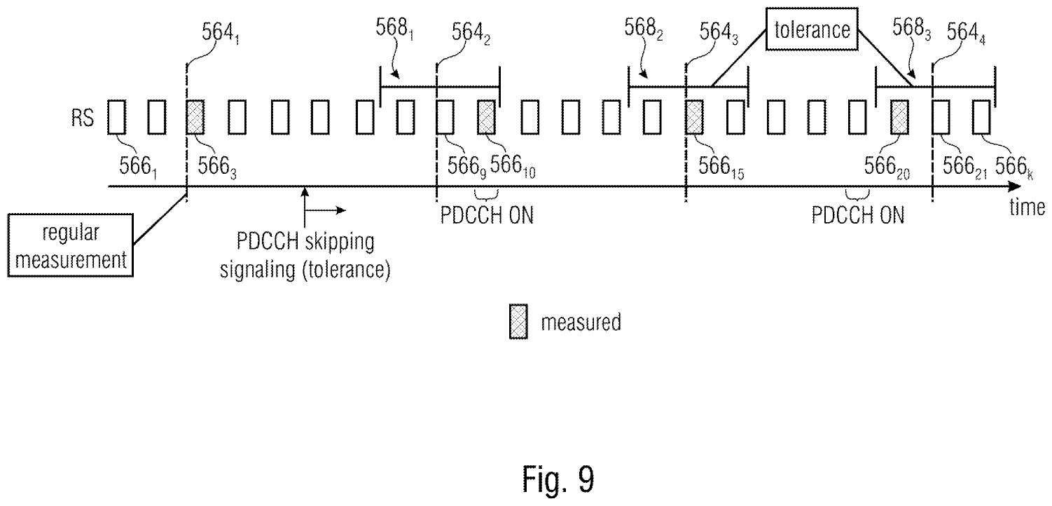

FIG. 9 illustrates a potential implementation of applying a tolerance window when activating PDCCH skipping. In the illustrative example an alignment between PDCCH skipping feature with other features, e.g., RLM, through tolerance window is provided.

For intended times 564₁ to 564₄ of measuring a reference signal, RS, 566₃, 566₉, 566₁₅, 566₂₁ respectively tolerance windows 568₁ to 568₃ are may be defined, wherein the tolerance windows 568₁ to 568₃ may have a same or different time duration. Within the tolerance windows 568₁ to 568₃ the transceiver may deviate from the times 564₁ to 564₄ of a regular measurement. A rule according to which the transceiver deviates may be configured or pre-configured or may be based on further parameters. For example, a closest distance in time may be selected, e.g., considering a measurement prior and/or after the intended time instance 564₁ to 564₄. Alternatively, only a prior measurement time as indicated for RS 566₂₀ may be allowed. Alternatively, only a later measurement time as indicated for RS 566₁₀ may be allowed.

Alternatively, or in addition, the tolerance window 568₁ to 568₃ may allow the transceiver for an own decision which RS to measure within the tolerance window

### Aspect 3: Opportunistic Relaxation

According to an embodiment the transceiver is to receive, from the wireless communication network an indication that the transceiver is allowed to interrupt all or some particular activity during the a part of during the complete duration of the skipping interval; and to operate accordingly.

According to an embodiment the transceiver is to interrupt the activity conditional on the transceiver being on a relaxation mode.

According to an embodiment the transceiver is to monitor the PDCCH and to perform at least one additional activity during a time outside the skipping interval; wherein the transceiver is to skip monitoring and for relaxing, e.g., skipping, the additional activity during the skipping interval.

According to an embodiment the additional activity is the feature.

According to an embodiment the transceiver is to receive a signal indicating a relaxation request to relax the additional activity together with the monitor the PDCCH and to operate accordingly.

According to an embodiment the transceiver is to receive the relaxation request as a general request, i.e. all UE reception can be skipped during the skipping interval; or as a specific request indicating a specific activity or a set of additional activities to be skipped, e.g., separate indications for radio link management, RLM, beam failure detection, BFD, and radio resource management, RRM.

According to an embodiment the request is specific for a serving cell, an intra-frequency, an inter-frequency and/or inter-radio access technologies, RAT, indications.

According to an embodiment the transceiver is to receive the request together with a PDCCH skipping command indicating to skip the monitoring, e.g. via DCI or a Search Space Set Group, SSSG, switching, or wherein the transceiver is pre-configured via a higher layer like, RRC, e.g., in radio resource control, RRC, it is configured that radio link measurement, RLM, measurements can be skipped every time a PDCCH skipping command indicating the skipping interval is sent within RLM relaxation state and wherein the transceiver is to deviate from the request if the transceiver is not on relaxation state.

According to an embodiment the transceiver is to relax for any condition, or only in case the transceiver is already on a relaxation state for a same or a different activity.

According to an embodiment the transceiver is to relax the activity only during the skipping interval, or also on top of other relaxation methods.

When the network enable PDCCH skipping it may send an indication that the UE can also skip other receiver activities (such as RLM, BFD and RRM measurements) during the duration of PDCCH skipping. This would effectively account as opportunistically relaxing such measurements (performing them less frequently than regular operation). The opportunistic relaxation may be applied alone, i.e. the measurements are only relaxed during PDCCH skipping time, or also on top of existing relaxation methods.

The indication can be general, i.e. all UE reception can be skipped during PDCCH skipping time, or specific, for example separate indications for RLM, BFD and RRM. The indications for opportunistic RRM relaxation may be further specified into serving cell, intra-frequency, inter-frequency and inter-RAT indications.

The indication(s) may be applied for any condition, or only in case the UE is already on a relaxation state.

The indication(s) may be sent together with the PDCCH skipping command, e.g. via DCI or SSSG switching, or they can be pre-configured via a higher layer like RRC. For example, in RRC it could be configured that RLM measurements can be skipped every time a PDCCH skipping command is sent within RLM relaxation state but it cannot be skipped if it is not on relaxation state.

### Embodiment 2

### Enable/Disable PDCCH Skipping

According to an embodiment the transceiver is to operate, during a first operating time interval, in a first operating mode in which skipping monitoring the PDCCH is enabled; and for operating, during a second operating time interval, in a second operating mode, in which skipping monitoring the PDCCH is disabled.

According to an embodiment the transceiver is to switch between the first operating mode and the second operating mode based on at least one of:
a radio link failure, RLF, detected;
a speed, e.g., when exceeding a (pre-)configured threshold;
an interference such as beam/Uu based when exceeding a (pre-)configured threshold;
a transceiver category;
a load of the transceiver; and
a quality of service, QoS, requirement.

According to an embodiment the transceiver is to operate in the second operating mode
completely;
for a defined period of time; or
until defined conditions change, e.g., a speed or interference reduction; or
until an event is received

According to an embodiment the transceiver is to operate in the first operating mode or in the second operating mode responsive to an operating mode information received from the wireless communication network.

Depending on certain conditions or setups or configurations, e.g.
RLF detected,
speed (e.g. when exceeding a (pre-)configured threshold),
interference (beam/Uu based when exceeding a (pre-)configured threshold)
UE category
Load of the UE
QoS requirements

PDCCH skipping could be deactivated/disabled e.g.
completely
   for a defined period of time or
   until defined conditions change (e.g. speed or interference reduction)
   Until an event is received

Depending on the UE category, PDDCH skipping may not be allowed or not enabled (e.g. by default).

The decision on the (re)activation/deactivation of PDCCH skipping might be made in a UE based on the events/pre-configurations or addressed by a gNB/network.

### Embodiment 3

Dynamic DRX by PDCCH Skipping

According to an embodiment the transceiver is to skip monitoring PDCCH based on a downlink control information, DCI, and for evaluating an downlink, DL, DCI or an uplink, UL, DCI, for a an information element that signals a PDCCH candidate providing a next opportunity for monitoring a PDCCH.

According to an embodiment the PDCCH candidate is a subsequent PDCCH for the transceiver, e.g., after having skipped at least one PDCCH.

According to an embodiment the information element represents a distance to a next PDCCH, and allows to enter a sleep period that ends prior to the next PDCCH.

According to an embodiment the distance comprises a value of at least ZERO.

According to an embodiment the information element is independent from a set of parameters in the DRX-Config information element (IE) from radio resource control, RRC.

According to an embodiment the information element is adopted from a drx-LongCycleStartOffset parameter in a DRX-Config IE.

According to an embodiment the information element indicates one of 20 different values which are extended by values for 0 to 9 ms.

According to an embodiment the information element comprises 5 bits or more than 5 bits.

According to an embodiment the transceiver is to estimate the PDCCH candidate in case of an absence of the information element or an unsuccessful decoding of the information element.

According to an embodiment the transceiver is to
assume a previous distance between PDCCH as a distance to the candidate PDCCH;
receive, from a base station a special DCI, e.g., similar to a wake-up signal, WUS, in a discontinuous reception, DRX, containing information indicating a new distance to a new candidate PDCCH
assume the previous distance and to send a NACK to indicate, to the base station, that a PDCCH decoding error has occurred if it has sent a PDCCH to cause the base station to retransmit at the distance the UE assumes; and/or
adopt the ON-duration DRX, wherein the ON-duration does not start at a fixed period, but flexibly at a wake-up after the last distance time.

DCI based PDCCH skipping can be regarded as an optimized and dynamic DRX procedure that also simplifies DRX considerably. For DCI based PDCCH skipping an information element is included in a downlink or uplink DCI that signals the next opportunity for a subsequent PDCCH. This information element may represent the number of slots after the current slot where the UE may not expect any, in other words distance to the next, PDCCH and can enter a sleep period.

Compared to state of the art DRX this new dynamic DRX is most flexible and entails least signaling.

While state the art DRX is based on periodic wake-up times, dynamic DRX can also support arbitrary irregular patterns, since each received PDCCH can signal a different distance to the next PDCCH. In that way it is even able to emulate state of the art DRX. For example, to emulate the on-duration the distance to the next PDCCH is set to 0 and this is continued if the inactivity or retransmission timer is started. At the end of the active duration the last DCI signals a long distance to the beginning of the next ON-duration. Even short cycles can be emulated in this way.

With dynamic DRX any distance at any time can be signaled thus realizing completely aperiodic and irregular patterns. This allows a much better optimization for power saving.

Also RRC signaling is greatly reduced, since the whole set of parameters in the DRX-Config information element (IE) from RRC is not needed. It is rather replaced by the one information element for the distance to the next PDCCH in DCI. As example, this distance parameter could be adopted from the drx-LongCycleStartOffset parameter in the DRX-Config IE, however, only the long cycle part is needed. That means, only 20 different values which should be extended by small values for 0 to 9 ms are needed. Thus, in this example the IE in the DCI uses only 5 bits. If the granularity for the PDCCH distance should be higher more bits can be provided.

The above principle is sufficiently parametrized if no PDCCH decoding errors are assumed and each opportunity a PDCCH is addressed to the current UE. If either a PDCCH is not decoded successfully or no PDCCH has been sent the distance information to the next PDCCH opportunity is missing. This could break the chain of subsequent wake-up opportunities. To overcome this issue the following counter-measures can be assumed
The UE assumes the previous distance.
The gNB sends a special DCI (similar to the WUS in DRX) with a new distance
The UE assumes the previous distance and sends a NACK. From the NACK the gNB can derive that a PDCCH decoding error has occurred if it has sent a PDCCH and retransmit at the distance the UE assumes.
Adopt the ON-duration from state of the art DRX. This provides some margin for the gNB to identify a problem and take correcting actions. The difference to state of the art DRX is that the ON-duration does not start at a fixed period, but flexibly at a wake-up after the last distance time.

Embodiments described herein relate to aligning/configuring the timing PDCCH skipping to save UE power with related RRM features such as RLM/RLF procedures is needed to reduce possible conflicts between power saving (PDCCH skipping) and fast response to any potential issues (e.g. decreased reliability due to possible RLF) on the RL. For example, embodiments may be used in power saving UEs or any other (5G) devices demanding power saving (e.g. RedCap UE, IoT devices), e.g. smart phones.

Solutions in accordance with embodiments are applicable to both static UEs as well as slowly moving UEs.

The network is in full control of when the solution is applied or not and to which extent. At the same time it allows for the UE to evaluate when it is safe to relax the RRM measurements.

The solution avoids making RRC reconfigurations for the sake of changing the measurement object set.

A wireless communication network in accordance with embodiments comprises:
at least one base station for serving a cell of the wireless communication network; and
at least one transceiver in the cell to communicate with a different transceiver or the base station;
wherein the transceiver is in accordance with an embodiment.

With regard to the second embodiment, the base station may send, to the transceiver, a signal indicating whether the transceiver is requested to operate in a first operating mode in which skipping monitoring the PDCCH is enabled; or to operate in a second operating mode, in which skipping monitoring the PDCCH is disabled.

With regard to the third embodiment, the base station may transmit, to the transceiver, an information element that signals a PDCCH candidate providing a next opportunity for monitoring a PDCCH to allow the transceiver skipping a monitoring of PDCCHs prior to the candidate PDCCH, the candidate having a distance in slots or in time to a present PDCCH; wherein the base station is to transmit, to different transceivers or to the same transceiver using subsequent information elements, different distances.

With regard to the third embodiment, the base station may receive a negative acknowledgement, NACK, responsive to a transmitted information element that signals a PDCCH candidate providing a next opportunity for monitoring a PDCCH, the candidate having a distance in slots or in time to a present PDCCH, wherein the base station is to retransmit the information element at a distance to the present PDCCH that equals a prior distance responsive to the NACK.

### General

Embodiments of the present invention have been described in detail above, and the respective embodiments and aspects may be implemented individually or two or more of the embodiments or aspects may be implemented in combination.

In accordance with embodiments, the wireless communication system may include a terrestrial network, or a non-terrestrial network, or networks or segments of networks using as a receiver an airborne vehicle or a spaceborne vehicle, or a combination thereof.

In accordance with embodiments, the user device, UE, described herein may be one or more of a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and using input from a gateway node at periodic intervals, or a mobile terminal, or a stationary terminal, or a cellular IoT-UE, or a vehicular UE, or a vehicular group leader, GL, UE, or an IoT, or a narrowband IoT, NB-IoT, device, or a WiFi non Access Point Station, non-AP STA, e.g., 802.11ax or 802.11be, or a ground based vehicle, or an aerial vehicle, or a drone, or a moving base station, or a road side unit, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

The base station, BS, described herein may be implemented as mobile or immobile base station and may be one or more of a macro cell base station, or a small cell base station, or a central unit of a base station, or a distributed unit of a base station, or an Integrated Access and Backhaul, IAB, node, or a road side unit, or a UE, or a group leader, GL, or a relay, or a remote radio head, or an AMF, or an SMF, or a core network entity, or mobile edge computing entity, or a network slice as in the NR or 5G core context, or a WiFi AP STA, e.g., 802.11ax or 802.11be, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

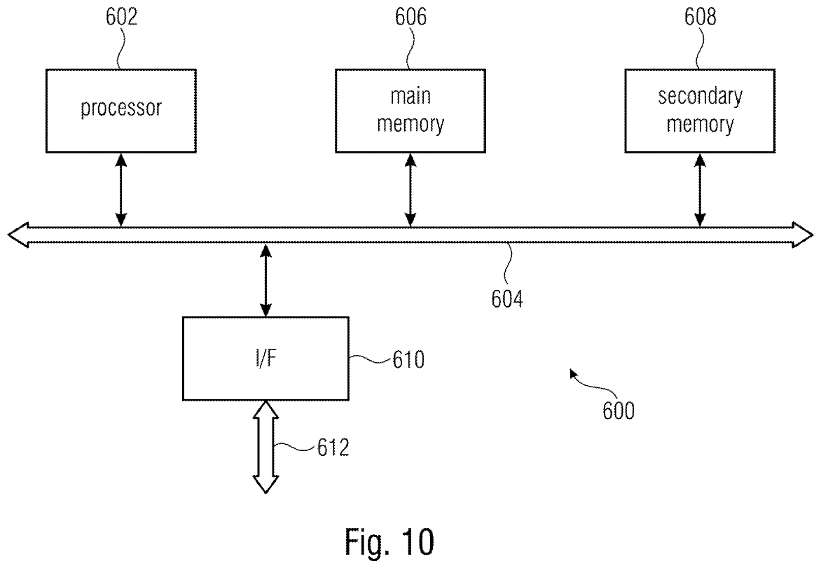

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 10 illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

In the following, additional embodiments and aspects of the invention will be described which can be used individually or in combination with any of the features and functionalities and details described herein.

According to a first aspect, a transceiver configured for communicating in a wireless communication network being operated by at least one base station may have: an antenna unit configured for transceiving wireless signals in the wireless communications network; wherein the transceiver is to monitor a physical downlink control channel, PDCCH to obtain downlink information; and to provide a feature such as a radio measurement in the wireless communication network; wherein the transceiver is to skip monitoring PDCCH by performing no monitoring or by switching a search space of the PDCCH, for a duration of a skipping interval and for aligning the feature with the skipping interval in time.

According to a second aspect when referring back to the first aspect, the transceiver is to obtain aligning information indicating a relationship between the skipping of the monitoring PDCCH and the feature and to align the feature with the skipping interval using the aligning information.

According to a third aspect when referring back to the second aspect, the alignment information may comprise at least one of: a time information indicating a time offset of the feature with respect to an end of the skipping interval; a tolerance information indicating a tolerance in time to execute the feature with regard to a reference in time at which the feature is scheduled by the wireless communication network; the tolerance in time indicating an amount of time by which the transceiver may deviate from the reference in time; a suspending information indicating that the feature is to be suspended, e.g., a radio measurement is to be skipped; an enablement information indicating to that PDCCH skipping is enabled or disabled; and an PDCCH occurrence information indicating an occurrence of a later PDCCH in time.

According to a fourth aspect when referring back to any of the first to third aspects, the transceiver is to monitor the PDCCH with a first pattern in time; and to perform a plurality of features including the feature with a second pattern in time.

According to a fifth aspect when referring back to any of the first to fourth aspects, the transceiver is to operate in a power saving mode, e.g., a sleep mode or a deep sleep mode, during the skipping interval.

According to a sixth aspect when referring back to any of the first to fifth aspects, the transceiver is to perform the feature on at least a part of the PDCCH.

According to a seventh aspect when referring back to any of the first to sixth aspects, for the skipping interval, e.g., a time where the transceiver enters or leaves PDCCH monitoring or enables PDCCH skipping a time offset is defined to be configured or preconfigured to align/realign an interaction between PDCCH skipping and the feature and/or between at least two features.

According to an eighth aspect when referring back to any of the first to seventh aspects, the transceiver is to apply a time offset to extend an already configured timer for the feature based on reference symbol monitoring such as configured CSI-RS, synchronization blocks, SSB or SSB based measurement timing configuration, SMTC to align the feature with the skipping interval in time.

According to a ninth aspect when referring back to the eighth aspect, the feature may comprise at least one of:
Measurements for RLM/RLF feature, and/or
Beam failure detection feature, and/or
RRM feature, and/or
any other corresponding features

According to a tenth aspect when referring back to any of the seventh to ninth aspects, the time offset may be configured or preconfigured considering at least one or any combination of the following parameters:
a reference symbol periodicity, e.g. CSI-RS periodicity
a synchronization block, SSB, periodicity
a SSB based measurement timing configuration, SMTC, window periodicity
a measurement gap configuration
a relative or absolute velocity of users, e.g., the transceiver
a Quality of Service, QoS, profile, e.g., packet delay budget
a traffic load of the transceiver (e.g. queue length, number of data flows, etc.)
a Validity timer set for PDCCH
a discontinuous reception, DRX, configuration
a transceiver category
a PDCCH skipping time interval
a beam configuration

According to an eleventh aspect when referring back to any of the seventh to tenth aspects, the transceiver may be configured for applying the time offset to perform the PDCCH skipping during the skipping interval until a next SMTC window, wherein the transceiver is to perform PDCCH monitoring during the next SMTC window.

According to a twelfth aspect when referring back to any of the seventh to eleventh aspects, the transceiver is to receive a signal comprising information indicating the time offset, e.g., indicating a time value or a flag bit, the information indicating to do PDCCH skipping until the end of a next measurement gap and to start monitoring PDCCH again just after the measurement gap.

According to a thirteenth aspect when referring back to any of the seventh to twelfth aspects, the transceiver is to provide a report comprising a result of an execution of the feature; wherein the transceiver is to provide the report with a delay with respect to a reference timing and for applying the delay according to a received delay information.

According to a fourteenth aspect when referring back to any of the seventh to thirteenth aspects, the transceiver is to provide the feature in a periodic or semi-persistent manner and is implemented for PDCCH skipping; wherein the transceiver is to skip the measurements with the time offset.

According to a fifteenth aspect when referring back to the fourteenth aspect, the time offset may comprise a same value in time to a skipping time duration indicating the duration of the skipping interval, the skipping time duration indicated by a radio resource control, RRC, or downlink control information, DCI, of the wireless communication network.

According to a sixteenth aspect when referring back to any of the seventh to fifteenth aspects, the transceiver is to derive the time offset from a radio resource control, RRC, message such as in a PDCCH-Config field description, or from a downlink control information, DCI, of the wireless communication network.

According to a seventeenth aspect when referring back to any of the seventh to sixteenth aspects, the transceiver is to evaluate a radio resource control, RRC, message or a downlink control information, DCI, of the wireless communication network for a time offset bit indicating information that toggles a flag that mandates the transceiver to consider or neglect the time offset based on configured time duration for PDCCH skipping.

According to an eighteenth aspect when referring back to the seventeenth aspect, the transceiver is to extend a measurement report or measurement of the transceiver with information indicating an inactivity timer responsive to an indication or pre-configuration and for a case where the previous measurement is insufficient for the wireless communication network due to an activation of PDCCH skipping.

According to a nineteenth aspect when referring back to any of the first to eighteenth aspects, the transceiver is to receive, from the wireless communication network, an indication indicating that the feature, e.g., measurements like RLM, BFD and/or RRM, can be performed by the transceiver prior and/or after a configured time and when PDCCH is monitored by the transceiver and outside the skipping interval.

According to a twentieth aspect when referring back to any of the first to nineteenth aspects, the transceiver is to provide the feature with a periodicity; wherein the transceiver is to receive, from the wireless communication network, an indication to deviate from the periodicity and wherein the transceiver is to deviate from the periodicity during the skipping interval accordingly.

According to a twenty-first aspect when referring back to the twentieth aspect, the transceiver is to provide the feature with respect to a serving cell of the wireless communication network and with respect to at least one intra-frequency neighbor cell around and during an active time outside the skipping interval during which the transceiver is to receive PDCCH and in case of a grant physical data shared channel, PDSCH.

According to a twenty-second aspect when referring back to any of the twentieth or twenty-first aspect, the transceiver is to perform the feature during a feature interval and to select the feature interval as having a closest distance in time with respect to a start or an end of the skipping interval and to be outside the skipping interval.

According to a twenty-third aspect when referring back to any of the twentieth to twenty-second aspects, the transceiver is to perform the feature at any time within a tolerance time window in alignment with the skipping interval.

According to a twenty-fourth aspect when referring back to any of the twentieth to twenty-third aspects, the periodicity may indicate periodic instances of time and wherein the transceiver is to perform the feature in advance of an associated periodic instance of time to deviate from the periodicity; and/or to perform the feature delayed with respect to an associated periodic instance of time to deviate from the periodicity.

According to a twenty-fifth aspect when referring back to any of the nineteenth to twenty-fourth aspects, the transceiver is to provide the feature within a tolerance window in time with respect to a regular provision; wherein a start, an end and/or a duration of the tolerance window is based on at least one of:
a reference symbol periodicity, e.g. a CSI-RS periodicity
a relative or absolute velocity of the transceiver;
a QoS requirement such as a delay;
a validity timer set for the PDCCH;
a discontinuous reception, DRX, configuration;
a transceiver category; and
a transceiver battery power level.

According to a twenty-sixth aspect when referring back to any of the first to twenty-fifth aspects, the transceiver is to receive, from the wireless communication network an indication that the transceiver is allowed to interrupt all or some particular activity during the a part of during the complete duration of the skipping interval; and to operate accordingly.

According to a twenty-seventh aspect when referring back to the twenty-sixth aspect, the transceiver is to interrupt the activity conditional on the transceiver being on a relaxation mode.

According to a twenty-eighth aspect when referring back to any of the first to twenty-seventh aspects, the transceiver is to monitor the PDCCH and to perform at least one additional activity during a time outside the skipping interval; wherein the transceiver is to skip monitoring and for relaxing, e.g., skipping, the additional activity during the skipping interval.

According to a twenty-ninth aspect when referring back to the twenty-eighth aspect, the additional activity may be the feature.

According to a thirtieth aspect when referring back to any of the twenty-eighth or twenty-ninth aspect, the transceiver is to receive a signal indicating a relaxation request to relax the additional activity together with the monitor the PDCCH and to operate accordingly.

According to a thirty-first aspect when referring back to the thirtieth aspect, the transceiver is to receive the relaxation request as a general request, i.e. all UE reception can be skipped during the skipping interval; or as a specific request indicating a specific activity or a set of additional activities to be skipped, e.g., separate indications for radio link management, RLM, beam failure detection, BFD, and radio resource management, RRM.

According to a thirty-second aspect when referring back to the thirtieth or thirty-first aspect, the request may be specific for a serving cell, an intra-frequency, an inter-frequency and/or inter-radio access technologies, RAT, indications.

According to a thirty-third aspect when referring back to any of the thirtieth to thirty-second aspects, the transceiver is to receive the request together with a PDCCH skipping command indicating to skip the monitoring, e.g. via DCI or a Search Space Set Group, SSSG, switching, or wherein the transceiver is pre-configured via a higher layer like, RRC, e.g., in radio resource control, RRC, it is configured that radio link measurement, RLM, measurements can be skipped every time a PDCCH skipping command indicating the skipping interval is sent within RLM relaxation state and wherein the transceiver is to deviate from the request if the transceiver is not on relaxation state.

According to a thirty-fourth aspect when referring back to any of the twenty-eighth to thirty-third aspects, the transceiver is to relax for any condition, or only in case the transceiver is already on a relaxation state for a same or a different activity.

According to a thirty-fifth aspect when referring back to any of the twenty-eighth to thirty-fourth aspects, the transceiver is to relax the activity only during the skipping interval, or also on top of other relaxation methods.

According to a thirty-sixth aspect when referring back to any of the first to thirty-fifth aspects, the transceiver is to operate, during a first operating time interval, in a first operating mode in which skipping monitoring the PDCCH is enabled; and for operating, during a second operating time interval, in a second operating mode, in which skipping monitoring the PDCCH is disabled.

According to a thirty-seventh aspect when referring back to the thirty-sixth aspect, the transceiver is to switch between the first operating mode and the second operating mode based on at least one of:
a radio link failure, RLF, detected;
a speed, e.g., when exceeding a (pre-)configured threshold;
an interference such as beam/Uu based when exceeding a (pre-)configured threshold;
a transceiver category;
a load of the transceiver; and
a quality of service, QoS, requirement.

According to a thirty-eighth aspect when referring back to the thirty-sixth or twenty-seventh aspect, the transceiver is to operate in the second operating mode
completely;
for a defined period of time; or
until defined conditions change, e.g., a speed or interference reduction; or
until an event is received

According to a thirty-ninth aspect when referring back to any of the thirty-sixth to thirty-eighth aspects, the transceiver is to operate in the first operating mode or in the second operating mode responsive to an operating mode information received from the wireless communication network.

According to a fortieth aspect when referring back to any of the first to thirty-ninth aspects, the transceiver is to skip monitoring PDCCH based on a downlink control information, DCI, and for evaluating an downlink, DL, DCI or an uplink, UL, DCI, for a an information element that signals a PDCCH candidate providing a next opportunity for monitoring a PDCCH.

According to a forty-first aspect when referring back to the fortieth aspect, the PDCCH candidate may be a subsequent PDCCH for the transceiver, e.g., after having skipped at least one PDCCH.

According to a forty-second aspect when referring back to the fortieth or forty-first aspect, the information element may represent a distance to a next PDCCH, and allows to enter a sleep period that ends prior to the next PDCCH.

According to a forty-third aspect when referring back to the forty-second aspect, the distance may comprise a value of at least ZERO.

According to a forty-fourth aspect when referring back to any of the fortieth to forty-third aspects, the information element may be independent from a set of parameters in the DRX-Config information element (IE) from radio resource control, RRC.

According to a forty-fifth aspect when referring back to any of the fortieth to forty-fourth aspects, the information element may be adopted from a drx-LongCycleStartOffset parameter in a DRX-Config IE.

According to a forty-sixth aspect when referring back to any of the fortieth to forty-fifth aspects, the information element may indicate one of 20 different values which are extended by values for 0 to 9 ms.

According to a forty-seventh aspect when referring back to any of the fortieth to forty-sixth aspects, the information element may comprise 5 bits or more than 5 bits.

According to a forty-eighth aspect when referring back to any of the fortieth to forty-seventh aspects, the transceiver is to estimate the PDCCH candidate in case of an absence of the information element or an unsuccessful decoding of the information element.

According to a forty-ninth aspect when referring back to the forty-eighth aspect, the transceiver is to
assume a previous distance between PDCCH as a distance to the candidate PDCCH;
receive, from a base station a special DCI, e.g., similar to a wake-up signal, WUS, in a discontinuous reception, DRX, containing information indicating a new distance to a new candidate PDCCH
assume the previous distance and to send a NACK to indicate, to the base station, that a PDCCH decoding error has occurred if it has sent a PDCCH to cause the base station to retransmit at the distance the UE assumes; and/or
adopt the ON-duration DRX, wherein the ON-duration does not start at a fixed period, but flexibly at a wake-up after the last distance time.

According to a fiftieth aspect, a wireless communication network may have: at least one base station for serving a cell of the wireless communication network; and at least one transceiver in the cell to communicate with a different transceiver or the base station; wherein the transceiver is in accordance with any of the first to forty-ninth aspects.

According to a fifty-first aspect when referring back to the fiftieth aspect, the base station is to send, to the transceiver, a signal indicating whether the transceiver is requested to operate in a first operating mode in which skipping monitoring the PDCCH is enabled; or to operate in a second operating mode, in which skipping monitoring the PDCCH is disabled.

According to a fifty-second aspect when referring back to the fiftieth or fifty-first aspect, the base station is to transmit, to the transceiver, an information element that signals a PDCCH candidate providing a next opportunity for monitoring a PDCCH to allow the transceiver skipping a monitoring of PDCCHs prior to the candidate PDCCH, the candidate having a distance in slots or in time to a present PDCCH; wherein the base station is to transmit, to different transceivers or to the same transceiver using subsequent information elements, different distances.

According to a fifty-third aspect when referring back to any of the fiftieth to fifty-second aspects, the base station is to receive a negative acknowledgement, NACK, responsive to a transmitted information element that signals a PDCCH candidate providing a next opportunity for monitoring a PDCCH, the candidate having a distance in slots or in time to a present PDCCH, wherein the base station is to retransmit the information element at a distance to the present PDCCH that equals a prior distance responsive to the NACK.

According to a fifty-fourth aspect, a method for operating a transceiver for communicating in a wireless communication network being operated by at least one base station, may have the steps of: transceiving wireless signals in the wireless communications network using an antenna unit of the transceiver; monitor a physical downlink control channel, PDCCH to obtain downlink information; and to provide a feature such as a radio measurement in the wireless communication network; skip monitoring PDCCH by performing no monitoring or by switching a search space of the PDCCH, for a duration of a skipping interval and aligning the feature with the skipping interval in time.

According to a fifty-fifth aspect, a computer readable digital storage medium may have stored thereon a computer program having a program code for performing, when running on a computer, a method according to the fifty-fourth aspect.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier, or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods may be performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### REFERENCES

[1] RP-211452 Status Report for WI UE Power Saving Enhancement for NR.
[2] TR-38840—Study on User Equipment (UE) power saving in NR
[3] Chairman's Notes, RAN1 #104e, Agreements for Reduced Capability NR Devices study.
[4] TS 38.213
[5] RP-210982 RedCap Status report

1. A user device, comprising:
a transceiver configured for communicating in a wireless communication network being operated by at least one base station,
wherein the transceiver is configured for transceiving wireless signals in the wireless communications network,
wherein the transceiver is configured to monitor a Physical Downlink Control Channel (PDCCH) to acquire downlink information, and to provide a feature in the wireless communication network,
wherein the transceiver is configured to skip monitoring the PDCCH by performing no monitoring for a duration of a skipping interval, for aligning the feature with the skipping interval in time, and
wherein the skipping interval includes a time where the transceiver enters or leaves PDCCH monitoring, or enables PDCCH skipping, and a time offset is configured to align an interaction between the PDCCH skipping and the feature.

2. The user device of claim 1, wherein the transceiver is configured to acquire aligning information indicating a relationship between the skipping of the monitoring PDCCH and the feature, and to align the feature with the skipping interval based on the aligning information.

3. The user device of claim 1, wherein the transceiver is configured to monitor the PDCCH with a first pattern in time and to perform a plurality of features comprising the feature with a second pattern in time.

4. The user device of claim 1, wherein the transceiver is configured to operate in a power saving mode, including a sleep mode or a deep sleep mode, during the skipping interval.

5. The user device of claim 1, wherein the transceiver is configured to perform the feature on at least a part of the PDCCH.

6. The user device of claim 1, wherein the transceiver is configured to apply a time offset to extend an already configured timer for the feature based on reference symbol monitoring including configured Channel State Information-Reference Signal (CSI-RS), synchronization blocks, Synchronization Signal Block (SSB) or SSB based Measurement Timing Configuration (SMTC) to align the feature with the skipping interval in time.

7. The user device of claim 6, wherein the feature comprises at least one of:
Measurements for Radio Link Monitoring (RLM)/Radio Link Failure (RLF) feature;
Beam failure detection feature;
Radio Resource Management (RRM) feature; or
any other corresponding features.

8. The user device of claim 5, wherein the time offset is configured considering at least one of the following parameters:
a reference symbol periodicity, including Channel State Information-Reference Signal (CSI-RS) periodicity;
a synchronization block or Synchronization Signal Block (SSB) periodicity;
an SSB based Measurement Timing Configuration (SMTC) window periodicity;
a measurement gap configuration;
a relative or absolute velocity of users including the transceiver;
a Quality of Service (QoS) profile including packet delay budget;
a traffic load of the transceiver including queue length or a number of data flows;
a Validity timer set for PDCCH;
a Discontinuous Reception (DRX), configuration;
a transceiver category;
a PDCCH skipping time interval; and
a beam configuration.

9. The user device of claim 5, wherein the transceiver is configured to derive the time offset from a Radio Resource Control (RRC), message including a PDCCH-Config field description, or from a Downlink Control Information (DCI), of the wireless communication network.

10. The user device of claim 5, wherein the transceiver is configured to evaluate a Radio Resource Control (RRC) message or a Downlink Control Information (DCI), of the wireless communication network for a time offset bit indicating information that toggles a flag that mandates the transceiver to consider or neglect the time offset, based on configured time duration for PDCCH skipping.

11. The user device of claim 1, wherein the transceiver is configured to receive, from the wireless communication network, an indication that the transceiver is allowed to interrupt all or some particular activity during a part or during a complete duration of the skipping interval, and to operate accordingly.

12. The user device of claim 1, wherein the transceiver is configured to skip the monitoring of the PDCCH based on a Downlink Control Information (DCI), and for evaluating an Downlink (DL), DCI or an Uplink (UL), DCI, for a an information element that signals a PDCCH candidate providing a next opportunity for monitoring the PDCCH.

13. The user device of claim 12, wherein the PDCCH candidate is a subsequent PDCCH for the transceiver including after having skipped at least one PDCCH; and
wherein the information element represents a distance to a next PDCCH, and the transceiver is allowed to enter a sleep period that ends prior to the next PDCCH.

14. A method for operating a user device including a transceiver for communicating in a wireless communication network being operated by at least one base station, comprising:
transceiving wireless signals in the wireless communications network based on the transceiver;
monitoring a Physical Downlink Control Channel (PDCCH) to acquire downlink information, and to provide a feature in the wireless communication network; and
skip monitoring the PDCCH by performing no monitoring, for a duration of a skipping interval and aligning the feature with the skipping interval in time, so that for the skipping interval including a time where the transceiver enters or leaves PDCCH monitoring, or enables PDCCH skipping, a time offset is configured to align an interaction between PDCCH skipping and the feature, or between at least two features.

15. A non-transitory digital storage medium having a computer program stored thereon to perform a method for operating a user device including a transceiver for communicating in a wireless communication network being operated by at least one base station, comprising:
transceiving wireless signals in the wireless communications network based on the transceiver;
monitor a Physical Downlink Control Channel (PDCCH) to acquire downlink information, and to provide a feature in the wireless communication network;
skip monitoring the PDCCH by performing no monitoring, for a duration of a skipping interval, and aligning the feature with the skipping interval in time, so that for the skipping interval including a time where the transceiver enters or leaves PDCCH monitoring, or enables PDCCH skipping, a time offset is configured to align an interaction between the PDCCH skipping and the feature and/or between at least two features, upon the computer program being run by a computer.
